(19) United States
(12) Patent Application Publication
(10) Pub. No.: US 2005/0268751 A1
(43) Pub. Date: Dec. 8, 2005

(54) Gearless one way drive

(76) Inventor: Nigel Alexander Buchanan, New Gilston (GB)

Correspondence Address: OSTRAGER CHONG FLAHERTY & BROITMAN PC, 250 PARK AVENUE, SUITE 825, NEW YORK, NY, 10177, US

(21) Appl. No.: 10/523,165

(22) PCT Filed: Aug. 1, 2003
(86) PCT No.: PCT/GB03/03369

§ 371 Date: Jan. 27, 2005

(30) Foreign Application Priority Data
Aug. 1, 2002 (GB) 0217845.7

(51) Int. Cl. B25B 13/18

(52) U.S. Cl. 81/64

(57) ABSTRACT

A head portion (2) and handle portion (3) pivot about an axis pin (6). The head portion (2) is first biased in the required drive direction (D) bias being sustained by a resilient cam (5) being to one side of a clamping shoe (7) centre line (7a). When torque is applied in the drive direction (D) to a levered end (3a) of the handle portion the resultant force acts through the pertinent cam (3c) on levered end (3b) of the handle portion forcing the clamping shoe (7) inwards locking the inner surface (2b) and clamping surface (7c) onto the drive portion (4) of a socket (8) or circular drive (9) in order to operate a fastener (10). A spring cam (5) takes up any play between the handle portion (3) head portion (2) axis pin (6) clamping shoe (7) and drive portion (4) yet compresses sufficiently to allow the instant gearless drive (1) relative to the drive portion (4) to be repositioned (R). The clamping shoe (7) is a sliding fit within the shoe slot (2c) can be conveniently operated against the resilient cam (5) by a release pin (11) within an appropriate slot (2e).

### FIELD OF THE INVENTION

The present invention relates to a gearless drive having a one way locking operation and more particularly, though not exclusively, concerns a tool similar in operation to a ratchet tool having a ratchet bar.

### BACKGROUND OF THE INVENTION

A ratchet bar tool may be used for applying torque via an attached square drive and appropriate socket to a nut, bolt or screw (hereinafter referred to as a fastener) for the purpose of tightening or slackening the fastener. The ratchet bar is movable relative to the socket in one direction only. Motion between the ratchet bar and the socket in the opposite direction is prevented by a set of angular teeth, which co-operate with a resilient pawl so as to create a locking motion in one direction only and free movement in the opposite direction. This operation of the socket and fastener via a ratchet bar is much more convenient in restrictive situations than the use of a fixed bar operated socket as there is seldom a requirement to remove and reattach the socket operating the fastener.

Variations of the ratchet bar are exhaustive. Most mechanisms have more and more locking teeth etc. to allow a smaller angle between drive, re-position and drive, resulting in mechanisms that whilst the angle between drive and reposition has been substantially reduced so has the amount of torque that can be safely applied to the ratchet bar without failure. The increasing intricacies of the ratchet mechanisms have also resulted in devices less tolerant to dirt or corrosion.

### SUMMARY OF THE INVENTION

It is an object of the present invention to provide an improved one way driving device.

According to the present invention there is provided a one way drive comprising a head having an aperture therein for loosely engaging a drive means, a handle mounted for pivotal movement about a pivot on the head, a movable member mounted on the head for movement into and out of the aperture in the head, and cam means located on the handle for engaging the movable member so that when the handle is pivoted, such engagement moves the movable member into the aperture so as increasingly to tighten the flexible head about the drive means as more torque is applied to the handle.

In one preferred embodiment in accordance with the present invention the movable member is slidably mounted on a flexible head and may have a surface which constitutes a part of the surface of the aperture in the head.

Conveniently, the cam means comprises a shoulder provided on at least one side of the handle, relative to a longitudinal axis of the handle, between the pivot and the movable member. The cam means may comprise two shoulders one on each corresponding side of the handle. The cam means may also comprise a resilient cam including a ball bearing and spring means located in a recess in the handle. Preferably, the recess which receives the spring means extends into the pivot about which the handle is pivotable.

Preferably, the recess which receives the ball bearing and spring means lies coaxial with the longitudinal axis of the handle. Alternatively, the recess receiving the spring means may extend in a direction transverse to the longitudinal axis of the handle. Preferably, the spring means comprises a compression spring.

An opening can be provided in the head and a retaining pin located in the opening for retaining the movable member within the flexible head.

Conveniently, the drive includes a retaining ring located between a head of the retaining pin and the flexible head of the gearless drive for securing fastening means relative to the flexible head in use of the gearless drive. The retaining pin may be movable in the opening so that the movable member can be engaged with or released from fastening means in the aperture of the flexible head of the gearless drive in use. The fastening means preferably comprises a fastener.

Alternatively, the fastening means comprises a drive socket mounted in use in the gearless drive for engaging a fastener as hereinbefore defined.

A detent may preferably project outwardly from the movable member into the aperture in the flexible head so as to engage in a groove in fastening means located in use in the aperture in the head of the gearless drive to retain the fastening means in the aperture. The aperture in the head may be circular.

Conveniently, an inner surface of the flexible head is cylindrical.

The flexible head may include side walls defining a closed chamber within the head and within which chamber the handle is pivotally mounted. A detent preferably projects inwardly from each of two opposed side walls for engagement by the cam means.

Fastener drive means may be provided for use with a gearless drive.

Alternatively, fastener drive means can comprise a circular-section spigot extending coaxially from a tool engageable with a fastener means.

In an alternative embodiment the aperture in the flexible head is preferably circular for engaging a circular drive means, such as a cylindrical spigot on a fastener socket drive. This provides an instant gearless drive version of a conventional ratchet bar, which will grip the spigot instantly when the handle is turned in the drive direction, yet will move relative to the spigot when the handle is turned towards a reposition direction. When increasing torque is applied in a drive direction (clockwise or counterclockwise) to the handle the action of the mechanism is such as to increase the locking action as more torque is applied.

In another embodiment of the present invention there is provided a head portion adapted to engage and apply torque to a variety of different fastener drives in order to tighten or release fasteners. An appropriate socket square drive or fastener drive can be inserted into the head portion so that the drive portion mates with the inner ring surface of the circular head aperture. Prior to use the head portion is biased in the drive direction relative to the handle portion by a spring-loaded detent arrangement. When a fastener is engaged and torque arm force is applied in a predetermined drive direction to the lever end of the handle portion, which is arranged to pivot about an axis pin via pivot points on the handle portion and pivot points on the head portion, the axis pin also mechanically holding the handle portion and the head portion together, the torque arm force applied to the lever end of the handle portion is substantially increased by the mechanical advantage of the lever action and the resultant force acts through the cam means onto the base of a clamping shoe constituting the aforementioned movable member, thus forcing the clamping shoe inwards onto the drive means and locking the drive means between the inner ring surface and the clamping surface of the shoe. The flexible ring of the head portion flexes to allow the inner ring surface to maximise its gripping surface on to the drive means. This clamping and locking serves to lock the flexible ring, clamping surface and drive portion together. The torque applied to the handle portion can then operate the fastener.

To prevent undue movement between the drive means and the flexible ring, the clamping shoe can have a resilient bias towards the drive portion sustained by a resilient cam. The resilient cam continuously exerts a resilient spring pressure between the levered end of the handle and the base of the clamping shoe usefully taking up any play between the handle portion, head portion, the clamping shoe and the drive means. The resilient cam tends to propel the clamping shoe inwards towards the drive portion.

When the head portion is biased in the drive direction relative to the handle portion, the resilient cam is moved to a position off centre relative to the shoe base. The resilient cam then tends to propel the handle portion in the drive direction and the drive cam is advantageously now resiliently sprung against the clamping shoe base.

When the handle portion is operated in the reverse or reposition direction the degree of clamping between the inner ring surface and the drive means is substantially decreased enabling the flexible ring to rotate, reverse or reposition relative to the drive means. Also the resilient cam is further compressed against the clamping shoe base. The strength of the resilient spring pressure exerted by the resilient cam is carefully chosen to prevent as far as possible any play between the drive portion, clamping shoe, head portion, handle portion and axis pin, yet not enough to prevent the clamping or locking action of the clamping shoe upon the drive portion being overcome allowing free movement in the reverse or reposition direction.

The instant gearless drive can thereby be used to drive various types of sockets, square drives or fastener drives with considerable torque in one direction and can be conveniently reversed or repositioned in the opposite direction.

In either embodiment the amount of play between use in the drive and reverse directions can for all practical purposes be negligible. The size of the head portion can be much reduced as compared to conventional ratchet drives, thereby allowing easier use of the instant gearless drive in restrictive situations. The change between drive and reverse or reposition directions can be achieved without turning the device upside down as in any single direction device or the use of an external direction lever or switch. Since the drive portion can be an integral part of the socket or fastener drive the overall height of the complete instant gearless drive can be substantially reduced.

The drive portion of the drive means can quickly and advantageously be withdrawn or dropped out of the flexible ring simply by urging the clamping shoe against the resilient cam so as to remove any clamping action from the drive portion and allow it to freely slide from the flexible ring. A release pin movable in a slot in the head portion, can be provided for this purpose and a retaining ring/washer associated with the release pin can usefully be employed to engage a retaining groove on the drive section of the fastener drive means to ensure that the gearless drive remains correctly axially positioned whilst being operated, and yet can be quickly disengaged by the operation of the release pin which withdraws the retaining ring/washer from the groove.

The invention also extends to a drive means having a circular cross-section drive portion or spigot engagable by the abovementioned gearless drive. At rest, the inner ring surface of the gearless drive and the clamping surface of the clamping shoe are essentially of the same diameter and lie parallel one with the other. The drive section of the drive means is also circular and concentric, and is able to rotate freely with a minimum of play within the flexible ring when the handle is not torqued. The clamping shoe can move lengthwise in a direction substantially parallel to the direction in which the longitudinal axis of the lever extends within the confines of a shoe slot within the head portion. The resilient cam can be extended or compressed within a resilient cam recess extending in the direction of the longitudinal axis of the lever within the levered end between the drive cams of the lever.

In another embodiment of the present invention, the resilient cam acts through a handle portion and axis pin onto the inner side walls of the head portion. The resilient cam(s) located at each of the opposite ends of the spring so that each ball engages a respective one of two opposed inner side walls of the radially outwardly extending part of the head portion.

When a wrench of the first embodiment is biased in a drive direction to, for example, tighten a fastener, the resilient cam is moved to a position off centre relative to the base of the shoe and a fixed cam on the lever engages the base of the shoe. In the case of the further embodiment, the resilient cam is moved off centre relative to the longitudinal axis through the lever arm and head portions in which a central-rest-position.

The resilient cams in the above mentioned further embodiment then tend to propel the handle portion in the required drive direction under the force of the spring bias, and the fixed drive cams are advantageously now resiliently sprung under the force of the expanding bias of the compression spring, against the base of the clamping shoe and hold in that position without additional torque applied to the lever or handle.

When the handle portion is operated in a reverse or reposition direction the degree of clamping between the inner ring surface and the drive means is substantially decreased enabling the flexible ring to rotate, reverse or reposition relative to the drive means. Simultaneously, the resilient cam of the first embodiment is further compressed against the base of the clamping shoe. The strength of the resilient spring pressure exerted on the resilient cam is carefully chosen to prevent, as far as possible, any play between the drive portion, clamping shoe, head portion, handle portion and axis pin, yet not enough to prevent the clamping or locking action of the clamping shoe upon the drive portion being overcome allowing free movement in the reverse or reposition direction.

Conveniently, a raised detent extends from each of two inner side walls of the head portion so that in the rest position of the gearless one way drive the detents compress the biasing spring so that the cam balls lie substantially within the recess in which the spring is located.

When torque is initially applied in either direction of the lever the cam balls move to one side (opposite sides of opposed detents) of each detent and the force of the compression spring forces the lever/handle into a position from which a drive force can be applied to tighten or release a fastener.

### DESCRIPTION OF THE DRAWINGS

Embodiments of the invention will now be described by way of example with reference to the accompanying drawings in which:

FIG. 1 is a perspective view of a first embodiment of an instant gearless one way drive in accordance with the present invention, the embodiment being shown biased in an anti-clockwise direction and engaged on one type of fastener, the stud of the fastener protruding through the centre of a fastener drive socket.

FIGS. 2a, 2b and 2c each show a sectional view in different operational states of the embodiment of FIG. 1, FIG. 2b showing a central non-drive position and FIGS. 2a and 2c showing the instant gearless drive biased anti-clockwise (FIG. 2a) and clockwise (FIG. 2c) and a resilient cam being shown extended and off centre against a clamping shoe which protrudes into a flexible ring of a head portion of the drive.

FIG. 3 is a dismantled elevational view of the gearless drive of FIGS. 1 and 2 showing the component parts thereof.

FIGS. 4a, 4b and 4c are sectional elevational views of another embodiment of an instant gearless drive in accordance with the present invention.

FIG. 5 illustrates a dismantled elevational view of the instant gearless drive of FIGS. 4a, 4b and 4c showing the component parts thereof.

FIG. 6 is a sectional view similar to that of FIG. 2a but including a retaining pin on the clamping shoe.

FIG. 7a is a side view of an exemplary drive socket useable with the described embodiments.

FIG. 7b is a right hand side end view of the drive socket of FIG. 7a.

FIGS. 8 through 8g illustrate several variations of drive sockets, square drives and other fastener drives useable with the described embodiments.

### DESCRIPTION OF THE EMBODIMENTS

The embodiments of the present invention will now be described with reference to the drawings. In the various embodiments and corresponding drawings like reference numerals will be used to indicate like features throughout.

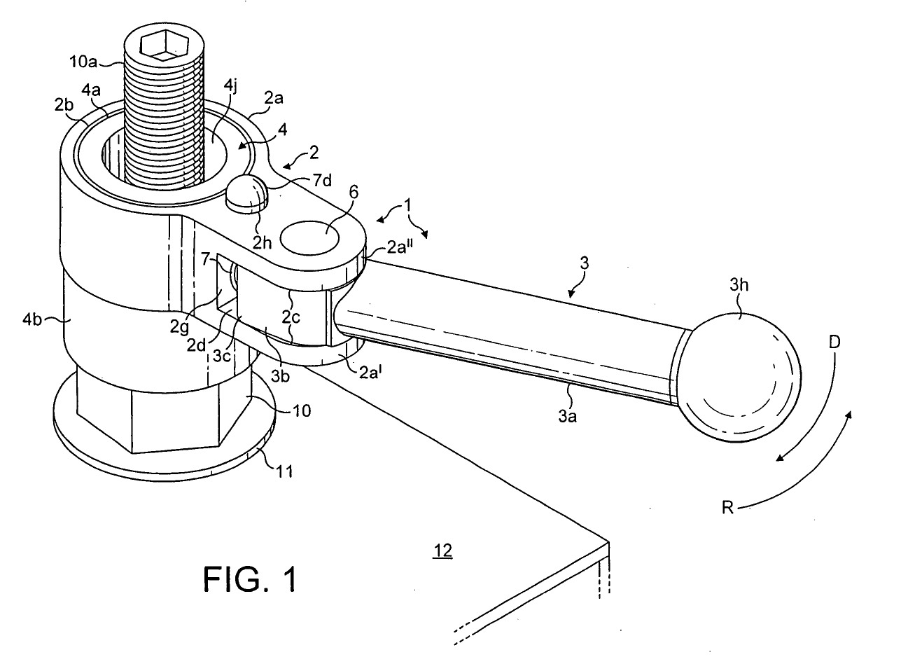

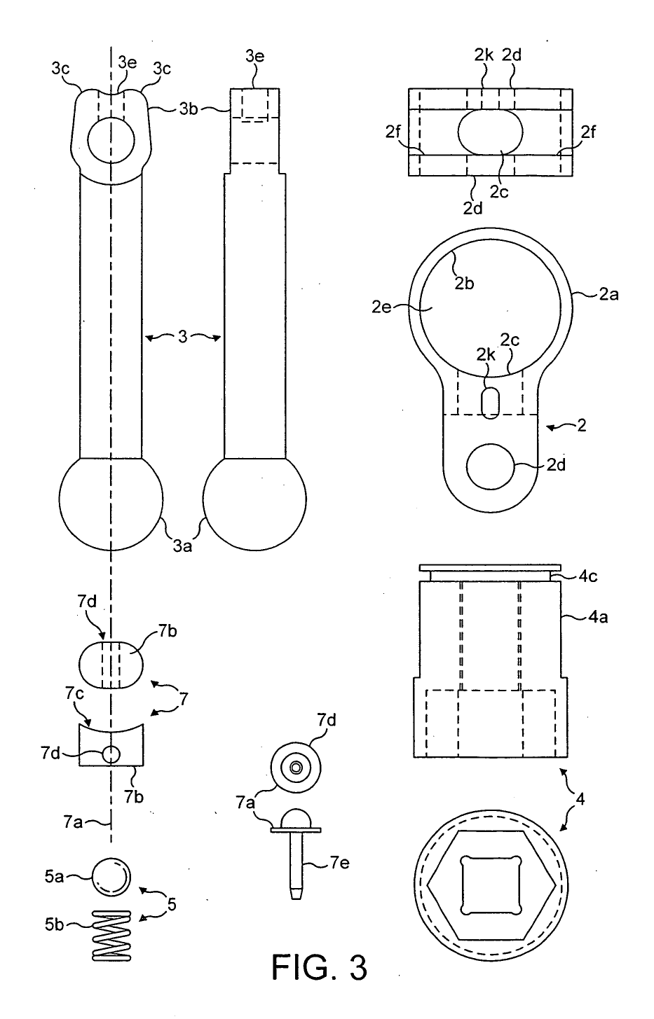

Referring to the drawings and in particular FIGS. 1 to 3, an instant gearless drive (1) comprises a head portion (2) and a handle portion (3) movable one relative to the other, both parts being formed of steel, for example. The head portion includes a flexible ring (2a) having an inner cylindrical ring surface (2b) and a shoe slot (2c). Flat planar spaced parallel arms (2a′) and (2a″) extend radially outward from the flexible ring (2a). The handle portion (3) is mechanically connected by an axis pin (6) through the arms (2a′) and (2a″) to the head portion (2) and projects into the space (2f) between arms (2a′) and (2a″) of the head portion.

The handle portion (3) comprises a lever end (3a), and an opposed levered end (3b) located between arms (2a′,2a″) of the head portion. A drive cam (3c) is located on either side of a cam recess (3d) in levered end (3b) of the handle (3). A fastener drive socket (4) has a drive portion (4a) removably located within the flexible ring (2a) and is non-drivingly engaged within the flexible ring by the action of resilient cam (5) against a clamping shoe (7). Driving engagement is obtained by the action of an appropriate drive cam (3c) on a base surface (7b) of the clamping shoe (7) which is slidable within the shoe slot (2c). As more and more torque forces are applied to handle portion (3) and hence clamping surface (7c) of the shoe against the drive portion (4), so the flexible ring (2a) flexes about drive portion (4a) thereby increasing the area of the inner ring surface (2b) in intimate contact with the drive portion (4a) for more securely clamping and locking the drive portion within the flexible ring (2a). The torque applied to the handle portion (3) is now directly transmitted to the socket (4), square drives (9) or fastener drives (12) in order to drive a fastener (10).

The instant gearless drive (1), in use, is usually biased in a drive direction (D) in which the resilient cam (5) is positioned to one side of a base surface (7b) of shoe (7) against the shoe and to the right of centre line (7a), when the drive direction (D) is clockwise. The resilient cam (5) is positioned to the left hand side of the base (7b) centre line (7a) when the drive direction (D) is anti-clockwise or in a reverse direction (R).

The resilient cam (5) preferably consists of a ball bearing (5a) and compression spring (5b) freely movable within cam recess (3d) within the handle portion (3) and aligned with a further cam recess (6a) within the axis pin (6). In either drive direction the resilient cam (5) takes up any play between the head portion (2), handle portion (3), axis pin (6) and clamping shoe (7).

A release pin (7e) is mounted in a slot or oversized hole (2h) in the head portion (2). The release pin (7e) extends through the head portion and is located in an aperture (7d) in shoe (7). Such arrangement allows movement of the shoe in its slot (2c) so as to enter or withdraw from within the flexible ring (2a) and effect clamping or release on drive portion (4a). Removal of the pin (7e) allows the shoe (7), when the gearless drive is disengaged from the drive portion (4a), to be removed from the gearless drive into the inner space (2e) within the flexible ring (2a).

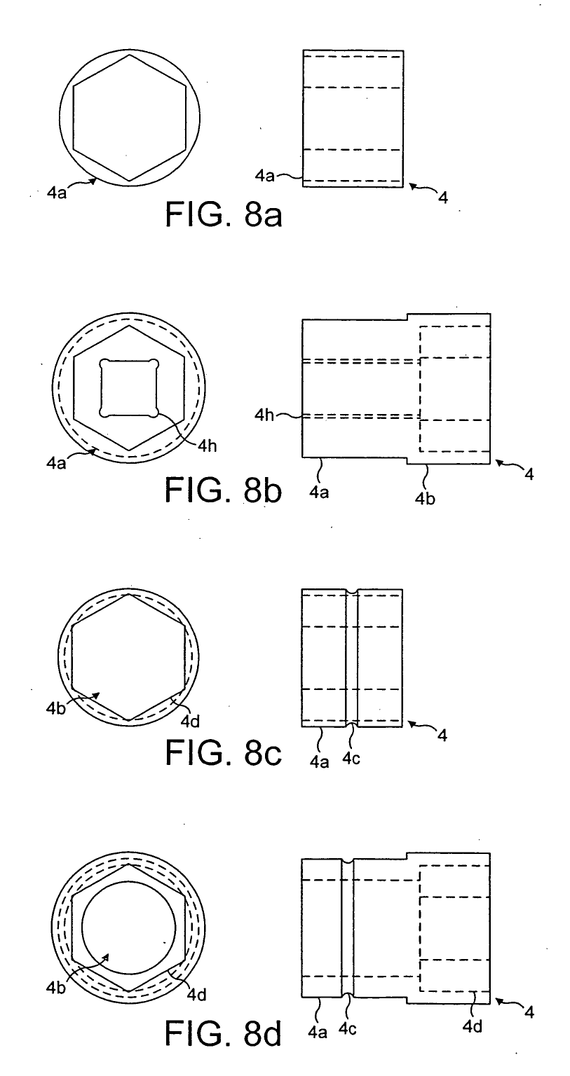

Conveniently, the release pin (7e) has a retaining ring/washer (7a) (FIG. 7) which can engage with and be disengaged from a retaining groove (4b) on the socket (4), thereby to keep the drive socket (4) in its optimum position relative to the inner ring surface (2b) of the flexible ring (2a). The socket (4) preferably has a through-hole (4j) to usefully allow a stud or threaded portion of a fastener (10) to protrude through the centre of the socket.

The inner surface (2b) of the flexible ring (2a), the gripping surface of the drive portion (4a), and the clamping surface (7c) of the clamping shoe (7) are all of a fine smooth finish to allow sliding movement therebetween.

Preferably the axis pin (6) is retained by known means within the handle portion (3) to allow the head portion (2) to pivot freely relative to the handle portion (3) without undue play.

The instant gearless drive (1) is adapted to engage and apply torque to a variety of different fastener drives (4), (4i), (12) in order to operate different types of fasteners (10).

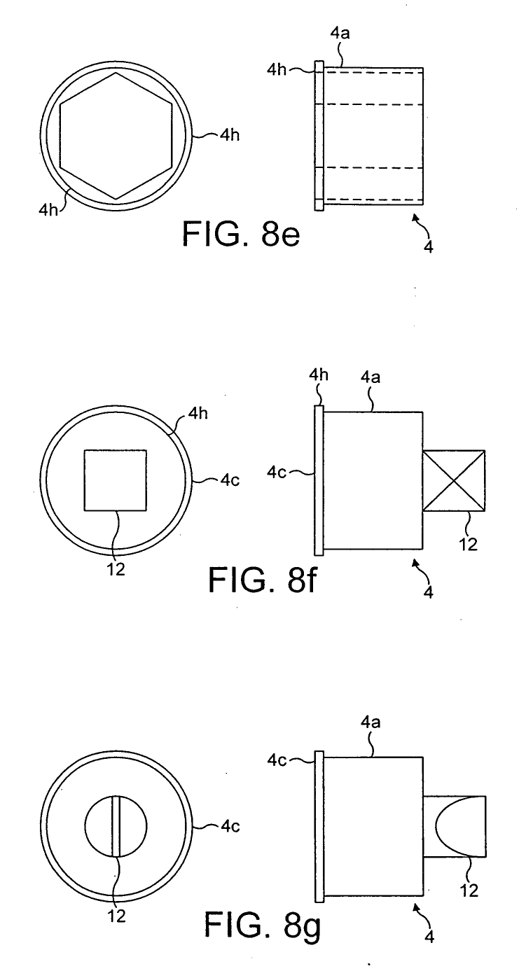

In use an appropriate drive socket (4), is selected and may have in addition to a cylindrical drive portion (4a), a post drive (4i) of square cross-section or fastener drive, such as a flat screwdriver tip (12) or any other shaped tip (FIG. 8g). The drive socket (4) can be inserted into the head portion (2) of the gearless drive so that cylindrical drive portion (4a) mates with the inner ring surface (2b) of the flexible ring (2a).

Prior to use the handle portion (3) is biased by the resilient cam (5) in the drive direction (D) for example, relative to the head portion (2) where it is held for placement of the flexible head portion (2) on drive socket (4). When a fastener (10) is engaged and torque is applied through socket (4) in the predetermined clockwise drive direction (D) to the lever end (3a) of the handle portion (3), the handle pivots in a clockwise direction around the axis pin (6) which also serves to mechanically hold the handle portion (3) and the head portion (2) together. Torque applied to the lever end (3a) of the handle portion (3) is substantially increased by the mechanical advantage of the lever action and the resultant force acts through the appropriate drive cam (3c) on to the base surface (7b) of the clamping shoe (7). The clamping shoe (7) is thereby forced inwards of the flexible ring (2a) into engagement with the drive portion (4a), thereby locking the drive portion between the inner ring surface (2b) and the clamping surface (7c) of the shoe (7).

The flexible ring (2a) of the head portion (2) flexes to allow the inner ring surface (2b) to maximise its gripping surface on the drive portion (4a). This clamping and locking serves to lock the flexible ring (2a), clamping surface (7c) and drive portion (4a) together. The torque applied to the handle portion (3) can then be usefully applied to operate the fastener (10).

Slippage between the drive portion (4a) and the flexible ring (2a) in pre-use engagement or repositioning of the gearless drive device is controlled by the clamping shoe (7) being resiliently biased against the drive portion (4a) and the biasing force is sustained by the resilient cam (5).

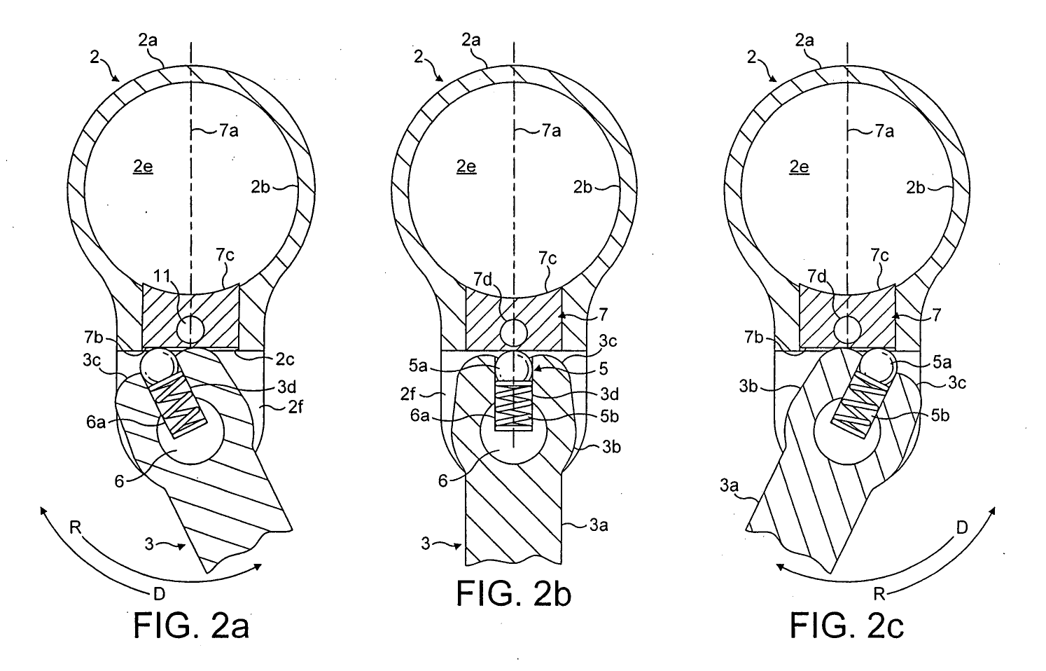

When the head portion (2) is biased in the clockwise drive direction (D) relative to the handle portion (3), the resilient cam (5) is moved to a position off centre relative to the shoe base (7b) (FIG. 2c). The resilient cam (5) then biases the handle portion (3) in the drive direction (D) and the drive cam (3c) is advantageously now forced against the clamping shoe base surface (7b) locking the gearless drive onto drive socket (4) and allowing additional force to be applied without slippage between socket and drive.

When the handle portion (3) is operated in the anti-clockwise reverse or reposition direction (R) and before the handle portion (3) goes over centre, the degree of clamping between the inner ring surface (2b) and the drive portion (4a) is substantially decreased, thereby enabling the flexible ring (2a) to slide in a reverse or reposition direction relative to the drive portion (4a). The biasing force on shoe (7) is then primarily the force exerted by the compression spring.

The force of the compression spring (5b) is selected so that the shoe (7) is pressed against the drive portion (4a) to prevent movement therebetween when applying further torque in a drive direction but such force is insufficient to cause full locking of the head portion on to the drive portion (4a) of drive socket (4). Therefore, when the handle portion (3) is moved in a reverse or reposition direction (R) but the handle portion (3) is not over centre, the flexible ring (2a) and shoe (7) slide around the drive portion (4a) to reposition the drive (1) relative to the socket (4).

More particularly, as handle portion (3) is moved from the drive direction (D) towards direction (R) the cam ball (5a) is pressed against the shoe surface (7b) compressing the spring (5b). Cam surface (3c) begins to disengage base surface (7b) of shoe (7) thereby reducing the force applied to shoe (7).

The force then required to move the handle portion (3) from the position shown in FIG. 2c to the position shown in say FIG. 2b is greater than the frictional force of the shoe surface (7c) against the socket drive portion (4a) and the gearless one way drive slidably rotates about drive portion (4a). Such operation particularly allows easy, simple, positive and instant repositioning of the drive (1) so as to continue to tighten, for example, fastener (10).

Once the drive is repositioned as described above, torque is removed in the reverse direction (R) and is reapplied in drive direction (D) in FIG. 2c, the compression spring (5b) urges the shoe (7) against drive portion (4a) which instantly clamps the drive (1) on socket (4) and urges the handle around in the drive direction (D). Cam (3c) is instantly engaged with shoe surface (7b) to apply immediate locking forces between the flexible ring (2a), shoe (7) and socket drive portion (4a) to enable further instant tightening of a fastener.

The gearless one way drive (1) operates in an identical manner if the drive (1) is used to release a fastener (10) and handle portion (3) is driven in a reverse direction (R) (FIG. 2a). Repositioning is obtained in the same manner as just described but by moving handle portion (4a) in the drive direction (D) in FIG. 2a.

The instant gearless drive (1) can thereby be used to drive various types of sockets (4), square drives (4i) or fastener drives (12) having a cylindrical drive portion of circular cross-section with considerable torque in one direction and to be conveniently reversed or repositioned in the opposite direction without disengagement from the drive socket (4) or the fastener (10).

The amount of play between use in the drive (D) or reverse (R) directions is for all practical purposes negligible. The size of the head portion (2) is much reduced over other known drives allowing easier use of the instant gearless drive (1) in restrictive situations without any reduction of applied torque. The change between drive (D) and reverse or reposition directions (R) can be achieved without turning the drive device (1) upside down as in any single direction device or the use of an external direction lever or switch. Since the drive portion (4a) is an integral part of the socket (4) or fastener drive (12) the overall height of the complete instant gearless drive (1) is substantially reduced.

The drive portion (4a) of the socket (4), square drive (4i) or fastener drive (12) can quickly and advantageously be withdrawn or dropped out of the flexible ring (2a) by moving the handle portion (3) to the position shown in FIG. 2b in which the gearless drive (1) can be disengaged from the drive portion (4a) of the drive socket (4). Once disengaged from socket (4) and with pin (7e) removed, the handle portion (3) can be moved in either drive (D) or reverse (R) directions whereupon the cam (3c) pushes the shoe (7) out into space (2e) within the flexible ring (2a). The shoe (7) can then be removed easily and replaced if necessary. A retaining ring/washer (7a) mounted on the release pin (7e) can usefully be employed to engage in the retaining groove (4b) on the drive portion (4a) of the socket (4), fastener drive (12) or square drive (4i) to ensure that the drive portion (4a) remains correctly axially positioned relative to the gearless drive (1) whilst being operated and yet can be quickly disengaged by sliding movement of the release pin (7e) in slot (2h) of the head portion (2). The inner flexible ring surface (2b) and clamping surface (7c) of shoe (7) share a common radius. The complementary drive portion (4a) is also cylindrical and coaxial with the inner surface of the flexible ring (2a). The drive portion (4a) is able to rotate freely with a minimum of play within the flexible ring (2a). The clamping shoe (7) can move lengthwise in a transverse radial direction to a central axis of cylindrical surface (2b) of flexible ring (2a), within the confines of the shoe slot (2c). The resilient cam (5) can be extended or compressed within the resilient cam recess (3d) within the levered end between the drive cams.

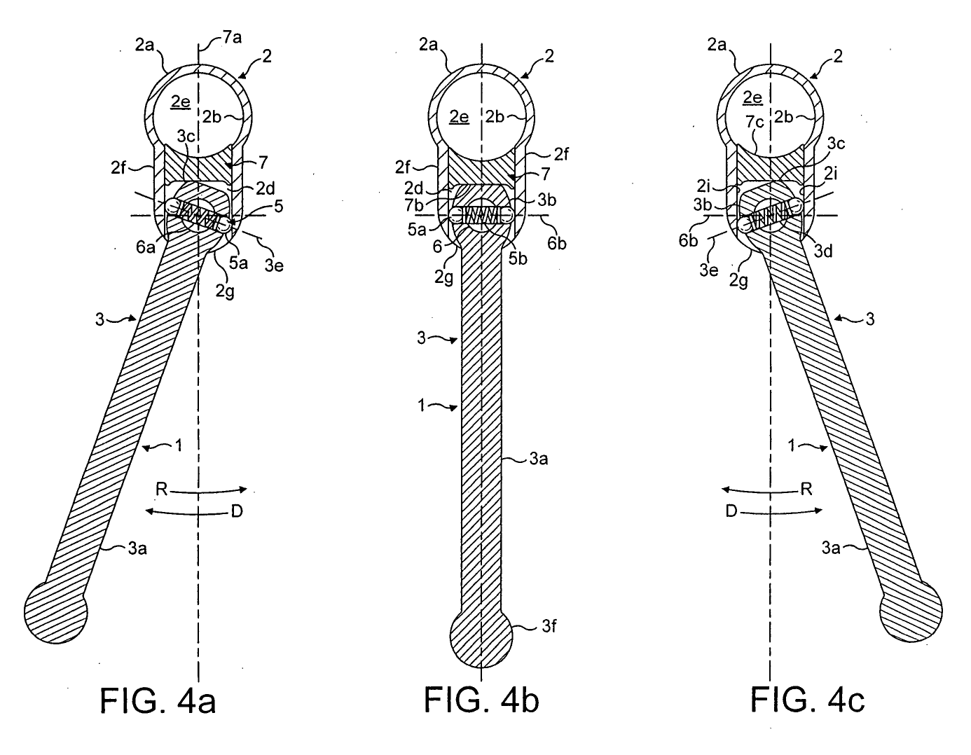

Another embodiment of a one way gearless drive is illustrated in FIGS. 4a, 4b and 4c. This embodiment operates in a substantially identical manner to the embodiment described with reference to FIGS. 1 to 3. The construction of the gearless drive of FIGS. 4a, 4b and 4c differs from the earlier described embodiment in some respects and therefore only the differences are described below.

Referring to FIG. 4a the flexible head (2) comprises an enclosed casing including flexible ring portion (2a) integrally formed with a radially outwardly extending closed chamber (2d) in which shoe (7) is mounted for sliding movement into or out of the flexible ring (2a).

One end (3b) of lever arm handle portion (3) is located in end slot (2g) of the flexible head (2) and mounted within the chamber (2d) for pivotal movement in drive and reverse directions, as previously described, about pivot pin (6).

However, passage (3d) passes through the end (3b) of handle (3) and the pin (6). Passage (6a) through pin (6) extends diametrically in a transverse direction perpendicular to the longitudinal axis of lever arm (3) and aligns with passage (3d) for receiving a compression spring (5b) and a cam ball (5a) at each end respectively of the spring (5b).

The radially outwardly extending hollow chamber (2d) is bounded on each of two sides thereof by opposed side walls (2f). Shoe (7) is of much larger dimensions than that of the embodiment of FIGS. 1 to 3 and therefore subtends a greater arc of the inner cylindrical surface of the flexible ring (2a) than that of the shoe of the previously described embodiment. Pressure can thereby be applied to socket drive portion (4) over a greater area than hitherto possible, improving the efficiency of the interlock between socket (4) and the flexible ring (2a).

The shoe (7) of the present embodiment of FIG. 4 fits snugly between the side walls (2e) of the flexible head (2) for an easy sliding fit therebetween and has a dished or recessed base surface (7b).

Internal surface (2i) of each side wall (2f) is provided with detent (6b) projecting inwardly into the chamber at a location therealong to be engaged with both the cam balls (5a), respectively, whenever lever arm (3) is in the position illustrated in FIG. 4b. However, a recess (6c) is provided in the peak of each detent to hold the cam balls (5a) and hence the gearless drive in the central position of FIG. 4b with the compression spring (5b) in a compressed state.

The detent (6b) in each case is otherwise a small smoothly curved protrusion extending out of each inner surface (2i) so that in the position shown in FIG. 4b the spring (5b) is compressed by the cam balls being forced back into the passageway (3d, 6a) by the detents (6b). The advantage of such construction is that when lever arm is moved in a drive direction to the left or right of the position shown in FIG. 4b the force of the compression spring (5b) is such as to force the cam balls (5a) down opposite sides of the detents (6b), respectively and to initially secure the lever arm (3) in either the positions shown in FIG. 4a or FIG. 4c depending upon whether a fastener is being tightened or released.

Further torque applied in either direction causes one cam surface (3c) to engage the recessed base surface (7b) of shoe (7) to move the shoe into the space (2e) within flexible ring (2a) and to lock the gearless drive onto drive portion (4a) of a fastening device or drive socket (4) of the kind shown in FIGS. 1 to 3 to tighten or loosen a fastener (10) as appropriate.

In the embodiment shown, the detents (6b) are smooth, curved and inwardly directed towards the interior of the chamber. The force of the compression spring (5b) ensures that the gearless drive (1), once the handle is moved to the left or to the right, is usually biased into one of the two positions as shown in FIG. 4a or 4c. Considering initially only the position with regard to FIG. 4a, further movement of the handle portion (3) in drive direction (D) to tighten a fastener, for example, forces cam surface (3c) against base surface (7b) of shoe (7) moving the shoe into the flexible ring (2a) against a drive portion (4a) of a drive socket (4) to lock the drive (1) and tighten the fastener as described with regard to the embodiment of FIGS. 1 to 3.

When working in a restricted space and it is not possible to turn the fastener further because of surfaces restricting the space in which the drive can move the gearless drive is repositioned by moving the handle end (3a) in the reverse direction (R). As the reverse force is applied the cam balls (5a) engage their respective detent (6b), on opposite faces thereof as shown in FIG. 4a. Further force in the reverse direction (R) causes the cam balls (5a) to move up the detents compressing the compression spring (5b). However, as the spring compresses the left hand cam (3c) moves to the left in FIG. 4a and releases pressure on base surface (7b) by an amount sufficient to allow relative sliding movement between the flexible ring (2a) and shoe surface (7c) on the one hand and drive portion (4a) of drive socket (4) on the other hand.

As mentioned above each of these surfaces (2b, 4a and 7c) is smooth and polished, thereby allowing free sliding movement therebetween.

The torque being applied in the reverse direction (R) overcomes any frictional component between surfaces (2b) and (7c) on the one hand and surface of drive portion (4a) on the other hand where upon the one way drive pivots around drive portion (4a) to reposition the drive (1) in the reverse direction (R).

As soon as the reverse torque (R) is removed the resilient cam (5) takes up any play between the component parts and the shoe (7) instantaneously grips drive portion (4a) of socket drive (4) to hold the flexible ring firm while handle portion (3) moves to the position shown in FIG. 4a. Instantaneously, any further applied torque to handle portion (3) in drive direction (D) is effective to turn the fastener (10). The gearless one way drive (1) operates in an identical manner to that just described to release a fastener, in FIG. 4c, with handle portion (3) in substantially the full reverse direction (R) to that of FIG. 4a with cam balls (5a) located against the opposite sides of their respective detents (6b) than in FIG. 4a.

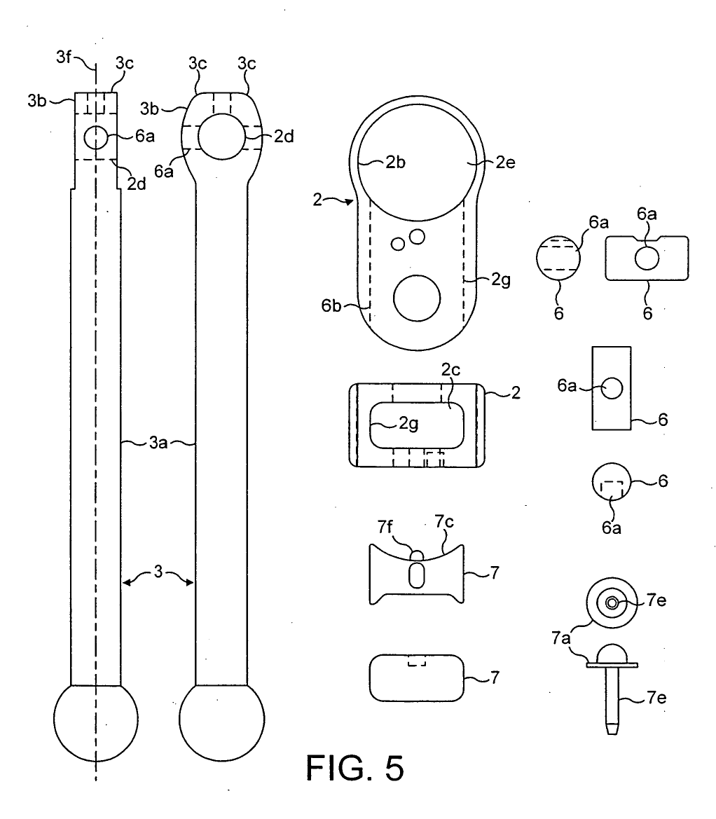

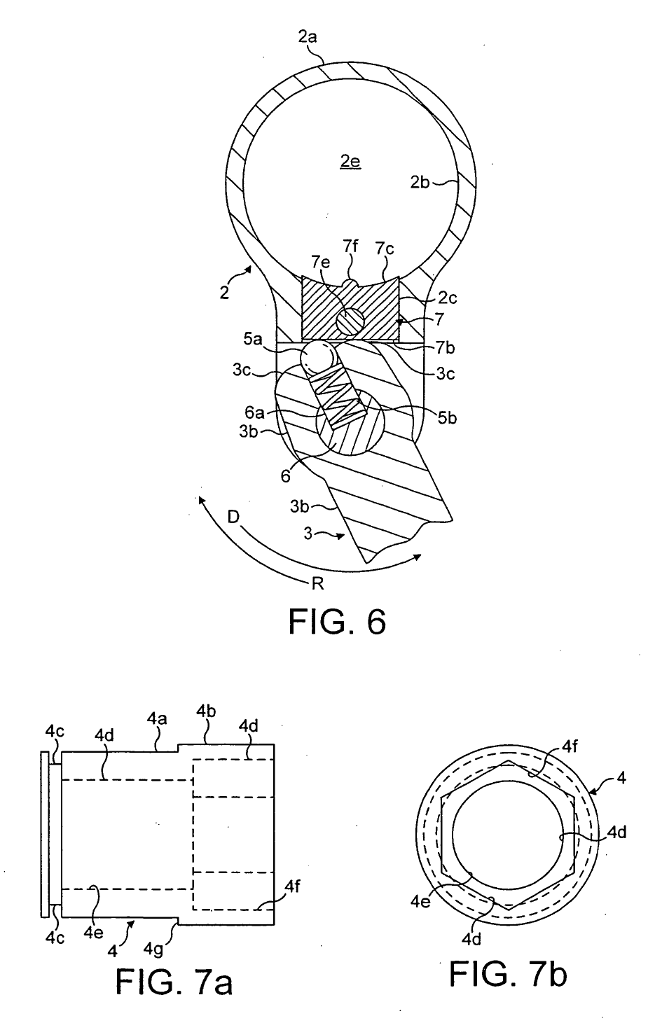

A retaining pin (7f) may project from the surface (7c) of the shoe (7) to engage the groove on the drive portion (4a) and thereby maintain axial alignment between the drive socket (4) and gearless drive device (1) as illustrated by the modified view in FIG. 6 of the embodiment described above with regard to FIGS. 1 to 3. The retaining pin (7f) may equally be used with the second embodiment of FIGS. 4a, 4b, 4c and 5 as illustrated in broken lines in FIG. 5.

A fastener drive socket (4) of the type used in regard to the above described embodiments is illustrated in FIGS. 7a and 7b. Referring, particularly to FIG. 7a the socket is cylindrical having a circular cross-section and first and second contiguous portions (4a,4b) of different external diametric lengths. However, the first and second portions may have equal diametric lengths, that is being of a constant external diameter throughout its axial length.

The reduced diameter portion in FIG. 7a has a groove (4c) at its end remote from the increased diameter portion (4b). The length of the groove (4c), in an axial direction of the cylindrical socket, is such as to receive therein the thickness of the disc/washer (7a) associated with pin (7e). Such interengagement ensures there is no axial displacement between the drive socket (4) and the gearless one way drive (1).

Internal surface (4d) extending through socket (4) may comprise any form suitable for engaging a particular fastener (10). In the socket of FIG. 7 the internal surface (4d) comprises two portions (4e,4f). The first portion (4e) has a cylindrical surface FIG. 7b of sufficient diametric width as to receive a stud (10a) therethrough (see FIG. 1) on which a fastener (10) can be tightened or release therefrom. The second portion (4f) in this instance is hexagonal in shape and is arranged to be used with a correspondingly hexagonal shaped fastener (10) of the appropriate size.

Irrespective of whether the groove (4c) is used to secure against axial displacement between the gearless drive (1) and socket (4) some degree of prevention of axial misalignment is achieved by the gearless drive abutting a radially outwardly extending surface (4g) between the two unequal diametric portions (4a,4b).

In FIG. 8 there are illustrated various forms of fastener drives which are appropriately recessed cylindrical sockets in FIGS. 8a through 8e or square peg or flat screwdriver drives in FIGS. 8f and 8g.

FIGS. 8b and 8d show socket drives similar in construction to the socket drive described with referenced to FIG. 7. However, the socket of FIG. 8b differs in that it has no external groove and the internal surface (4d) over portion (4e) has a square shaped cross-section. The socket of FIG. 8d differs from that of FIG. 7 in that the groove (4c) rather than being located at one end of drive portion (4a), it is located approximately half way along the axial length of portion (4a) and is therefore ideally suited for engagement by a gearless drive having the construction found in FIG. 6 in which the retaining pin (7f) projects from shoe surface (7c) into groove (4c). However, maximum area of shoe face (7c) engages the outer cylindrical surface of drive portion (4a) of socket (4).

The sockets of FIGS. 8a and 8c differ from the socket of FIGS. 7a and 7b in that they are of a length equal to the length of drive portion (4a) of the socket of FIGS. 7a and 7b and have a hexagonal shaped interior surface throughout the whole of its length. The socket of FIG. 8a has no external groove while that of FIG. 8c includes an external groove approximately half way along its length. The socket of FIG. 8c is therefore ideally suited to use with the gearless drive (1) of FIG. 6 in which pin (7f) engages in groove (4c).

The socket drive of FIG. 8e is substantially the same as the socket of FIG. 8a other than the socket of FIG. 8e but has additionally a radially outwardly extending flange (4h) which assists in preventing axial displacement of the socket in the flexible ring (2a) of a gearless drive.

The drives of FIGS. 8f and 8g are not sockets but have similar external cylindrical surfaces (4a), with radially outwardly extending flange (4h) as in FIG. 8e. In FIG. 8f a post (12) of square shaped cross-section projects outwardly of the drive in the same direction as a rotational axis of the drive.

The drive of FIG. 8f is ideally suited to driving a known drive socket or one such as that in FIG. 8b or square socket directly on the fastener (10).

The drive shown in FIG. 8g is substantially the same as that of the drive of FIG. 8f but has a flat screwdriver blade (12) for engaging a groove in a fastener.

Either of the drives shown in FIGS. 8f and 8g and the socket of FIGS. 8a to 8e can be driven by gearless drive (1) engaging external cylindrical surface (4a) in each instance.

Any other variations of drive sockets for other drives are possible. The common feature between them is that they each have an external drive surface which is cylindrical and engagable by a gearless one way drive as described above in any one of its appropriate embodiments. Alternatively, the one way drive can be applied directly to the head of a fastener having a polygonal shape but in which the flat sides thereof have become badly burred, the circular/cylindrical inner surface (2b) of the gearless drive (1) being ideally suitable to engage the burred edges and turn the fastener.

1. A one way drive comprising a flexible head having an aperture therein for loosely engaging drive means, a handle mounted for pivotal movement about a pivot on the head, a movable member mounted on the head for movement into and out of the aperture in the head, and cam means located on the handle for engaging the movable member so that when the handle is pivoted, such engagement moves the movable member into the aperture so as increasingly to tighten the flexible head about the drive means as more torque is applied to the handle.

2. A drive as claimed in claim 1, wherein the movable member is slidably mounted on the head.

3. A drive as claimed in claim 2, wherein the movable member has a surface which constitutes a part of the surface of the aperture in the head.

4. A drive as claimed in claim 1, wherein the cam means comprises a shoulder provided on at least one side of the handle, relative to a longitudinal axis of the handle, between the pivot and the movable member.

5. A drive as claimed in claim 4, wherein the cam means comprises two shoulders one on each corresponding side of the handle.

6. A drive as claimed in claim 1, wherein the cam means comprises a resilient cam including biasing means located on the handle.

7. A drive as claimed in claim 6, wherein the biasing means is effective in use to semi-clamp the drive onto the drive means to allow torque to be applied to the handle without the head being moved relative to the drive means.

8. A drive as claimed in claim 6, wherein the biasing means comprises spring means.

9. A drive as claimed in claim 8, wherein the handle defines a recess which receives the spring means.

10. A drive as claimed in claim 9, wherein the recess extends into a pivot about which the handle is pivotable.

11. A drive as claimed in claim 9, wherein the recess is coaxial with a longitudinal axis of the handle.

12. A drive as claimed in claim 9, wherein the recess extends in a direction transverse to a longitudinal axis of the handle.

13. A drive as claimed in claim 8, wherein the biasing means includes a cam ball at an end of the spring means.

14. A drive as claimed in claim 8, wherein the spring means comprises a compression spring.

15. A drive as claimed in claim 1, wherein an opening is defined in the head and further comprising a retaining pin located in the opening for retaining the movable member within the flexible head.

16. A drive as claimed in claim 15, including a retaining ring located between a head of the retaining pin and the flexible head for securing said drive means relative to the flexible head.

17. A drive as claimed in claim 15, wherein the retaining pin is movable in the opening so that the movable member can be engaged with or released from said drive means in the aperture of the flexible head.

18. (canceled)

19. (canceled)

20. A drive as claimed in claim 1, further comprising a detent projecting outwardly from the movable member into the aperture in the flexible head so as to engage in a groove in said drive means located in the aperture in the head to retain the drive means in the aperture.

21. A drive as claimed in claim 1, wherein the aperture in the head is circular.

22. A drive as claimed in claim 1, wherein an inner surface of the flexible head is cylindrical.

23. A drive as claimed in claim 1, wherein the flexible head defines a chamber within which chamber an end of the handle is pivotally mounted.

24. A drive as claimed in claim 23, wherein the flexible head includes opposed side walls defining opposite sides of said chamber and further comprising respective detents projecting from said side walls for engagement with the cam means.

25. (canceled)

26. (canceled)

27. A tool for use in applying a rotary force to a part, said tool comprising:
a resilient member that has an inner wall defining an aperture for receiving said part;
a movable member carried by the resilient member and movable with respect to said aperture; and
a lever arm pivotably connected with the resilient member and pivotable between positions in which it applies a force to said movable member such that said inner wall and member are forced against said part to apply a rotary force to the part that increases as an input torque applied to the lever arm increases so that the part moves with the resilient member and a release position in which the force applied to the movable member and inner wall is reduced to permit the lever arm to move the resilient member relative to the part.

28. A tool as claimed in claim 27, wherein said inner wall is circular and defines an opening through which said movable member can move into said aperture.

29. A tool for applying a rotary force to a fastener, said tool comprising:
a drive member having a cylindrical body portion and a formation configured to engage a predetermined fastener;
a head having an inner wall defining an aperture for receiving said body portion of said drive member and defining a recess for a movable member;
a movable member disposed in said recess and movable therein for releasably engaging said body portion when said driver member is received in said aperture;
a lever arm pivotable about a pivot mounted on the head and having an end engageable with the movable body; and
at least one resiliently biased member carried by said lever arm,
said end of the lever arm being configured to define a neutral position of the lever arm, first drive positions when the lever arm is pivoted in a first direction from said neutral position and second drive positions when the lever arm is pivoted in a second direction from said neutral position, which second direction is opposite to said first position, wherein in said first and second positions respective first and second engaging portions of said end of the lever arm engage said movable member to apply a force to said movable member that presses said movable member against said body portion of the drive member received in said aperture and causes a portion of said head defining said inner wall to flex against said body portion to apply a rotary force to the body portion that increases as an input torque applied to the lever arm increases so causing the drive member to move with the head and in said neutral position said first and second engaging portions being moved out of engagement with said movable member whereby an input torque applied to said lever arm causes said head to rotate relative to the drive member.

30. A tool as claimed in claim 29, wherein said at least one resiliently biased member engages a detent provided on one of said head and said movable member when said lever arm is in said neutral position.
